(19) United States
(12) Patent Application Publication
(10) Pub. No.: US 2006/0172076 A1
(43) Pub. Date: Aug. 3, 2006

(54) Autodeposition metal dip coating process

(75) Inventors: Brett A. Rearick, North East, PA (US); Rebecca S. Cowles, Wattsburg, PA (US)

Correspondence Address: LORD CORPORATION;PATENT & LEGAL SERVICES, 111 LORD DRIVE, CARY, NC, 27512, US

(73) Assignee: Lord Corporation

(21) Appl. No.: 10/684,056

(22) Filed: Oct. 10, 2003

Related U.S. Application Data
(63) Continuation-in-part of application No. 10/231,621, filed on Aug. 30, 2002.
(63) Continuation-in-part of application No. 10/609,116, filed on Jun. 27, 2003.

(51) Int. Cl. B05D 1/18; B05D 3/02; B05C 19/02

(52) U.S. Cl. 427/430.1; 427/299; 427/372.2; 118/423; 118/412; 118/429; 118/66

(57) ABSTRACT

An apparatus or system for handling and processing of substrates, more specifically electro-chemically active metal substrates, including a bath or dipping station having an autodepositable coating composition. In one embodiment, the apparatus is a square transfer apparatus having a plurality of stations including at least one metal pretreatment or cleaning station, and at least one autodepositable coating composition station. An operation as performed at each station is completed within a predetermined unit cycle time. A method for utilizing a square transfer apparatus including at least one step comprising coating a substrate with an autodepositable coating composition at an autodeposition station is disclosed.

### CROSS REFERENCE

This application is a continuation-in-part of U.S. patent application Ser. No. 10/231,621 filed Aug. 30, 2002, entitled “Improved Autodeposition Metal Dip Coating Process” and U.S. patent application Ser. No. 10/609,116 filed Jun. 27, 2003, entitled “Improved Coating Process Utilizing Automated Systems,” both herein fully incorporated by reference.

### FIELD OF THE INVENTION

The present invention relates to dip-application of aqueous autodepositable compositions. In one embodiment, a square transfer apparatus is described which includes at least two bath or dipping stations, with at least one dipping station comprising an aqueous autodepositable composition, and a device capable of moving a substrate in a travel path including the at least two dipping stations. Movement of a series of racked substrates in unison from station to station is controlled by a unit cycle time. In one embodiment, a method for applying at least one aqueous autodepositable composition to a substrate utilizing a square transfer apparatus is disclosed.

### BACKGROUND OF THE INVENTION

Autodeposition is an aqueous process for coating metal that is driven by reactions between the coating and metal substrate when small amounts of multivalent metal ions are released from the metal surface. The aqueous composition must contain a stabilized polymer dispersion. The essential feature of an autodepositable coating is that the dispersed material is stabilized by functional groups on the polymer and/or provided by surface active agents which are sensitive to multivalent ions entering the aqueous phase. Deposition occurs by interaction of the multivalent ions and these stabilizing functional groups causing the dispersion to precipitate when sufficient concentration of multivalent ions occurs at the metal surface.

Examples of autodepositing compositions are disclosed, for example, in European Patent Publication 0132828, Bashir M. Ahmed, U.S. Pat. No. 4,647,480 and Wilbur S. Hall, U.S. Pat. No. 4,186,219, U.S. Pat. No. 4,657,788, U.S. Pat. Nos. 5,691,048, and 4,657,788, and patents cited therein each of which is incorporated herein by reference. Such compositions designed to particularly effective when the resin material is provided in the form of a dispersed polymer such as a sulfonate-functionalized novolak, or latex made from the emulsion polymerized product of at least two polymerizable ethylenically unsaturated monomers.

In the practice of dip-applied autodeposition coatings, often the coating can be rinsed after withdrawal from the bath. In some instances, rinsing is not undertaken. There remains some limits on the process of autodepositing coatings on metal parts without a rinse step. A problem arises without a rinse step relating to accumulation of drainage along edges, that when dried leads to what is referred to as drip edges. These drip edges result in poorer protective coatings. In attempts to alleviate drip edges other problems can arise, such as variable dry film thickness (DFT) in different areas of the part surface. The need for a non-rinsing coating method that deposits a sufficient amount of coating, with an acceptable DFT uniformity, while reducing the incidence of drip edges would be highly desirable in a dip-applied autodeposited coating.

### SUMMARY OF THE INVENTION

A square transfer apparatus is described comprising at least one station having an autodeposition composition which is autodeposited on a substrate dipped in the composition during a dipping step. The square transfer apparatus has a travel path which preferably includes a loading station, an unloading station, and a predetermined number of additional processing stations therebetween. In one embodiment, the station comprises a rail and carriage system utilized to transfer a substrate from station to station along the travel path. In a further embodiment, a reciprocating system is utilized and includes a plurality of substrate handling devices movable between a first and second station. A unit cycle time is utilized to control movement of the substrate from one station to the next station to the step transfer apparatus, thereby maximizing throughput and overall efficiency of the system.

In one embodiment, the square transfer apparatus includes at least one metal substrate pretreatment dipping station and at least one autodeposition coating station located after the pretreatment station. In a preferred embodiment, the pretreatment dipping stations include an alkaline cleaning solution station, an acid pickle cleaning station, and at least one rinsing station.

After any pretreatment steps are performed on the substrate, an autodepositable coating composition is autodeposited on the substrate at a least one dip coating station of the square transfer apparatus. In one embodiment, an autodepositable metal treatment is applied to the electrochemically active substrate through autodeposition. In another embodiment, a metal treatment coating and a separate autodepositable primer coating or an adhesive overcoating composition is applied to the substrate through autodeposition. In yet another embodiment, an autodepositable composition is applied at a station to a electrochemically active metal substrate, wherein the coating functions as a metal treatment, primer, and an adhesive.

Advantageously, each autodeposition step is performed within the predetermined unit cycle time of the square transfer apparatus. In one embodiment rapid bath turnover is practiced wherein an autodepositable coating composition is replaced in a given tank at a given rate such as a period of hours to days. In another embodiment the substrate is removed from an autodepositable composition at a withdrawal rate which is less than the drainage rate of the coating from the surface of the substrate. In a further embodiment, dual rate withdrawal is utilized to remove a substrate from an autodepositing composition. With the methods of the present invention, the formation of teardrops or inconsistent coating thicknesses on the surface of the substrate are avoided or minimized.

According to a preferred aspect of present invention there is provided a no-rinse autodeposition process to dip-apply a metal part in an aqueous coating bath containing a specified solids level, at a specified bath temperature, immersion time and, wherein the removal rate of the dipped part is kept equal or below drainage rate of mobile liquid portion, such that upon removal of the part, drip edge formation is minimized and a DFT is maintained within acceptable tolerance levels.

### BRIEF DESCRIPTION OF THE DRAWINGS

The invention will be better understood and other features and advantages will become apparent by reading the detailed description of the invention, taken together with the drawings, wherein:

FIG. 1 is a flow diagram of a travel path for one embodiment of a preferred step transfer apparatus of the present invention.

### DETAILED DESCRIPTION OF THE PREFERRED EMBODIMENTS

Unless otherwise indicated, description of components in chemical nomenclature refers to the components at the time of addition to any combination specified in the description, but does not necessarily preclude chemical interactions among the components of a mixture once mixed.

As used herein the term “autodeposited resin” shall mean all resins which can be autodeposited in the autodeposition process.

DFT is dry film thickness, and is measured using a Fisherscope MMS Permascope and an average of 10 readings are taken as the statistical sample on each part or panel.

“Primer” means a liquid composition applied to a surface as an undercoat beneath a subsequently-applied covercoat. The covercoat can be an adhesive and the primer/adhesive covercoat forms an adhesive system for bonding two substrates together.

“Coating” means a liquid composition applied to a surface to form a protective and/or aesthetically pleasing coating on the surface.

“Electrochemically active metals” means iron and all metals and alloys more active than hydrogen in the electromotive series. Examples of electrochemically active metal surfaces include, but are not limited to, zinc, zinc phosphatized steel, iron, aluminum and cold-rolled, polished, pickled, hot-rolled and galvanized steel.

“Ferrous” means iron and alloys of iron.

The transfer apparatus of the present invention is utilized to convey a substrate or article through a series of stations, at least one of which comprises a bath or dipping station having at least one autodepositable coating which is applied to the substrate via autodeposition. The transfer apparatus is preferably as a square transfer, step transfer, or walking beam apparatus, governed by a uniform operating station unit cycle time. The square transfer apparatus conveys the substrate through a series of stations wherein various processes are performed simultaneously on electrochemically active metal substrate. A preferred embodiment involves utilizing the square transfer apparatus to perform operations such as multiple metal pretreatment steps and application of an autodepositing coating composition, simultaneously at all work stations on racked substrates in a series of processing baths or stations in accordance with a predetermined program.

The square transfer apparatus in one embodiment includes a series of horizontally arrayed metal substrates corresponding to the number of work stations, including pretreatment dipping stations, rinse stations, dehydration stations, and at least one autodeposition coating dipping station through which the series of arrayed substrates are conveyed. Preferably, the apparatus includes, prior to the pretreatment stations, a loading station and after the dehydration station, an unloading station with a predetermined number of stations therebetween. In one embodiment, the square transfer apparatus includes racks, or trays or other substrate holding elements, movable along a predetermined travel path via a travel system. Examples of types of travel systems include, but are not limited to, a rail and carriage system, a conveyor line, transporter, or the like. In a preferred embodiment, the series of racked. substrates are suspended from a travel system, such as a carriage and rail system and lowered and raised out of several dipping tanks at various stations simultaneously before being transferred to a next stage in unison, coordinated by the unit cycle time. The square transfer apparatus includes generally from 4 to 8 metal pretreatment stations including their rinsing stations, desirably from 1 to 2 autodeposition coating stations, and conveyance to a drying oven. Optionally racks exiting the drying oven are conveyed to a second dip coating station, followed by conveyance to a curing or bake oven.

Movement of the substrate along the travel path of the square transfer apparatus is controlled by an indexer or other electromechanical device which is operatively connected to a control system such as a computer, central processing unit, or other programmable logic controller (PLC) having an operator interface. In one embodiment, the travel path of the step transfer apparatus is a continuous system, path, or loop, wherein the series of arrayed substrates each operatively connected to a rack or other transporting device are sequentially transferred from the first pretreatment station through the autodeposition coating station, and removed to a drying oven.

To maximize efficiency and throughput, one carrying rack per station is utilized. It is important to note that different movements or processes are performed at each station independently of movements or processes at other stations taking place within the unit cycle time. The series of racked parts follows the sequence of pretreatment and coating from the first cleaning, and rinse stations to autodeposition metal coating the station along the travel path of the square transfer apparatus with a third rack following the second rack, and so on. The racks collectively move in unison from one station to another during a predetermined unit cycle time. A Unit cycle time is measured from a starting point when a first substrate or rack reaches a predetermined position at a first station, i.e., time zero, and ends when the substrate or rack has been conveyed or transferred to the next station and reaches the same predetermined position at a second station or a second substrate or rack which enters the first station and reaches the same predetermined position, wherein the time elapsed from time zero in the unit cycle time. As explained herein, any number of operations are carried out on a substrate operatively connected to a rack at a station during a given unit cycle time for purposes of the present invention. A unit cycle time ranges generally from 30 to 180 seconds, desirably from 45 to 120 seconds, and preferably from 60 to 90 seconds.

The substrate is operatively connected to the travel system through the rack. In one embodiment, the travel system is detachably connected to the rack or other substrate holding element. Generally the rack is suspended from the travel system to facilitate or allow dipping in a tank at one or more stations. The rack is configured to hold a predetermined number of substrates. The rack has one or more levels for holding parts, with examples including, but not limited to, single level racks, double level racks and multi-level tier racks. Single level racks are preferred to maximize coating consistency and minimize drip edges and/or tearing. In a preferred embodiment, the rack comprises a plurality of hooks or other substrate holding elements which orient the substrate in predetermined positions.

In some embodiments, the travel system includes a plurality of reciprocal carriages which are each movable between two stations. In this case, the carriage is detachable from a rack so the rack is left at a station and retrieved by a second carriage and moved to the next station. For example, in one embodiment a first carriage transports a substrate containing rack from a prior station to a station such as a cleaning station or an autodeposition coating station. The first carriage then directly transfers the rack to a second carriage or, alternatively, deposits the carriage at the station wherein the second carriage retrieves the rack from the deposited location. Afterwards, the second carriage transfers the rack to a subsequent station. Rack movement from station to station is performed within the predetermined unit cycle time.

Each travel system preferably comprises one or more stations which includes a hoist or lifting mechanism which is movable preferably in a vertical direction. The hoist is at least used to raise and lower a substrate into a bath or dipping solution at various stations. The motion of the hoist is controlled either mechanically or with a microprocessor, or a combination thereof. Generally hoists are operated pneumatically or with a screw drive. Hoist systems are known in the art and are commercially available. Each hoist is individually programmed such as by a PLC to perform a series of tasks or movements in a predetermined time period within a unit cycle time.

In a preferred embodiment, one or more autodeposition coating steps are performed within a cycle time which is less than the unit cycle time and also the cycle time for a metal pretreatment step. In a further embodiment, the hoist mechanism is utilized to perform an autodeposition coating step at a dual rate of withdrawal.

As noted herein, the square transfer apparatus includes at least one station for autodepositing a coating onto the surface of a substrate. The apparatus preferably includes at least one station which performs a metal pretreatment on a substrate before transfer to one or more autodeposition coating stations. Stations which are optionally included in various embodiments of the apparatus are described hereinbelow.

A loading station is generally the first station of the square transfer apparatus of the present invention. At the loading station, one or more substrates are either automatically or manually loaded onto a rack which is operatively connected to a travel system. The number of substrates loaded onto a rack is predetermined according to process parameters such as tank size, tank depth, etc. In one embodiment, the loading and/or unloading station includes a PLC controlled robot or robot arm, such as disclosed in U.S. Ser. No. 10/609,166 herein incorporated by reference, which is utilized to place and/or remove a substrate from a rack, or attach a racked substrate to the travel system of the apparatus. In a preferred embodiment, the substrate is transferred from the loading station along the travel path to a pretreatment station, such as a zinc phosphating station, an alkaline cleaning station or an acid pickle station.

Various stations of the step transfer apparatus comprise a bath or dipping solution which is housed in a container such as a tank. Generally any type of tank can be utilized which is non-reactive with the solution contained therein. Examples of suitable tanks for various stations include metal tanks such as stainless steel or aluminum, or polymeric tanks such as a crosslinked polymer or polyethylene, polypropylene or ABS with stainless steel and crosslinked polymer tanks preferred. Tank size is determined by factors including dimensions of the substrate(s), rack, and desirability of bath turnover. In some embodiments, a tank includes a heater in order to maintain a solution therein at a predetermined temperature range, a temperature sensing probe, solution level sensing means, a circulation pump, an agitator, an ultrasonic wave producing devices, an overflow collector, an electrocleaning device, an eductor for increased agitation, or a sparger, or a combination thereof. In some embodiments, an exhaust hood or vent is situated above a tank in order to remove tank vapors to another area. In one embodiment, tanks from 2 or more stations are connected in series through pipes or tubes and a counterflow system is established in order to maintain an upstream tank with a relatively clean or pure solution. Used or old solution is pumped upstream and/or out of the system according to a predetermined cycle in order to counterflush the series of tanks.

An alkaline cleaning station is utilized in one embodiment of the step transfer apparatus of the present invention. An alkaline cleaning composition comprises a solution of potassium hydroxide, sodium hydroxide, or the like. Optionally included are stabilizing agents and/or surfactants. The alkaline cleaning station performs a metal pretreatment step on a substrate before an autodeposition coating is applied thereto. In one embodiment, the alkaline cleaning station includes an eductor, an ultrasonic wave producing device or an electrocleaning device, or a combination thereof. The pH of the alkaline cleaning solution ranges from greater than 7 to 14 which hydrolyzes or saponifies oils present on the surface of a substrate. The preferred temperature range for alkaline cleaning in one embodiment is 71° C. (160° F.) to 87° C. (190° F.). In a preferred embodiment, three alkaline cleaning stations are utilized and are connected in a series along the travel path so that the oldest solution can be counterflushed out of the system and disposed of.

In a preferred embodiment, it is desirable to provide a rinse station to remove any remaining solution present on the surface of the substrate from a prior station before a further process is performed upon a substrate at subsequent station. In one embodiment, a rinse station includes a tank comprising water, preferably deionized water. In one embodiment, the rinse station is utilized at room temperature. In a preferred embodiment, the rinse station utilizes an air bubbler to increase agitation, or a pump and eductors, or a combination thereof.

An acid pickle cleaning station is utilized in a preferred embodiment of the step transfer apparatus of the present invention. An acid pickle bath or dipping solution comprises an acidic solution generally comprising phosphoric acid, sulfuric acid or the like and has a pH of 1 to less than 7. The acid cleaning station at least cleans soils, rust, or the like from the substrate. In a preferred embodiment, at least one rinsing station is provided after an acid pickling station. The one or more rinsing stations are optionally heated to 37° C. (100° F.) to 65° C. (150° F.).

After the substrate has been processed at the predetermined metal pretreatment station(s), if any, the substrate is operatively transferred to an autodeposition coating station via the travel system of the square transfer apparatus. In one embodiment, an autodepositable metal treatment is applied to the electrochemically active metal substrate throughout autodeposition. In another embodiment, a metal treatment coating and a separate autodepositable primer coating or an adhesive overcoating composition are independently applied to the substrate throughout autodeposition. In yet another embodiment, a composition is applied at a station to an electrochemically active metal substrate, wherein the coating functions as a metal treatment, a primer, and an adhesive, by autodeposition.

In one embodiment, rapid bath turnover is practiced. Rapid bath turnover is defined as the replacement or replenishment of a predetermined volume of a coating composition in a tank at a station in a period of generally from 1 hour to 5 days, and preferably from 1.5 hours to 1 day due to use or depletion. Rapid bath turnover allows utilization of inherently unstable or low stability coating compositions due to the rapid consumption thereof utilizing the methods of the present invention. In one embodiment, the coating composition components are mixed within a short amount of time, within 1 or 2 seconds to about 1 or 24 hours, prior to addition to a tank or utilization to coat electrochemically active metal substrates. In a further embodiment, a coating supply or replenishment line or system well known to those or ordinary skill in the art is utilized to add a coating composition to a tank of the present invention. The coating supply system is controlled by the microprocessor or central processing unit as known in the art, and is set to optionally mix components of a coating composition and dispense a predetermined volume of the composition into a tank for a predetermined time at predetermined intervals. In one embodiment, the volume of the electrochemically active metal substrate(s) when immersed displaces generally at least about 0.25%, desirably at least about 1.0%, and preferably at least about 5% of the volume of the autodepositionable coating composition in the tank.

There are generally no restrictions as to the temperature of treatment of the substrate in an autodepositable coating at one or more stations. Ordinarily, the autodepositable coating compositions are maintained at a temperature generally from 0° C. to 50° C. and preferably from 15° C. to 25° C. The duration of the substrate immersion in the autodepositable compositions is less than the unit cycle time and is dependent primarily on predetermined desired film thickness and the amount of accelerator present, if any. In a preferred embodiment, immersion time begins when the substrate reaches the lowest position in a dipping tank or when the last portion of the substrate is located within the composition. In a preferred embodiment, the substrate is immersed at a rate of about 1 meter per second in order to minimize top to bottom coating thickness differences. Immersion time in an autodepositable metal treatment ranges from 10 to 45 seconds and preferably from 10 to 30 seconds. Other autodepositable coatings such as primer and adhesives generally have an immersion time of from 15 to 45 seconds and preferably from 15 to 30 seconds. The total film thickness of the one or more autodeposited coating compositions on the surface of the substrate, when measured after drying, is generally from 0.1 mil (2.54 micrometers) to 2.0 mils (50.8 micrometers) and preferably from 0.8 mil (20.3 micrometers) to 1.5 mils (38.1 micrometers). The film thickness of a single autodeposited metal treatment coating composition, when measured after drying, is generally from 0.1 mil (2.54 micrometers) to 1.0 mil (25.4 micrometers) and preferably from 0.5 mil (12.7 micrometers) to 0.8 mil (20.3 micrometers).

In a preferred embodiment, dual rate withdrawal is utilized during removal of a substrate from an autodepositing composition. At an autodeposition station, a substrate is immersed into an autodepositing composition for a predetermined period of time. The substrate is subsequently withdrawn from the composition at least two different rates of removal. In one embodiment, the coated substrate is removed from the autodeposition composition at a rate of 1.2 to 2.5 cm per second (0.5 to 1 inch per second) and then at a rate of 0.25 to 1.0 cm per second (0.1 to 0.4 inches per second). Preferably, the first relatively fast rate of withdrawal is performed for a duration of from 55 to 95 percent, and preferably 90 percent of total withdrawal time. Thus, the slower rate of withdrawal is practiced during 5 percent to 45 percent and preferably 10 percent of the total withdrawal time. The dual withdrawal rate is preferably performed utilizing a microprocessor controlled hoist mechanism as described herein. The second, slower withdrawal rate is performed at a rate which is less than the drainage rate of the coating from the surface of the substrate. The dual withdrawal rate provides the substrate with a substantially teardrop free appearance. That is, when utilizing a withdrawal rate less than the drainage rate, even with a single rate of withdrawal, formation of teardrops on the substrate is avoided. In a preferred embodiment, after the substrate is completely removed from the coating, the lifting speed or rate of withdrawal is increased to a predetermined rate such as a rate of 3.0 to 20 cm per second.

In a preferred embodiment, an autodeposition station is equipped with a tank comprising an overflow system, as well as a composition inlet line, in order to maintain the autodepositing composition at a predetermined level or height within the tank. In this manner, consistent coating of substrates is achieved. In one embodiment, an autodeposition coating tank is provided with a blowing mechanism such as an air knife or air pulse device which is utilized to break bubbles, if any are present on the surface of a substrate. A uniform flow of air is provided across a tank in a predetermined direction in order to reduce and/or eliminate tear formation on a substrate during withdrawal. Preferably, the blowing mechanism is located close to the surface of a tank so that bubbles, if present, can be broken before the substrate is completely withdrawn from the autodepositing composition. That is, the blowing mechanism is preferably located less than 1 foot from the surface of the autodepositing composition and preferably less than 6 inches from the surface of the autodepositing composition.

In one embodiment, the withdrawn substrate is articulated through one or more predetermined motions in order to improve coating uniformity, facilitate drainage of excess or pooled material, or prevent drip edges or overly thick areas of coating from developing. For example, in various embodiments the withdrawn coated substrate is moved in an arc or other path, moved in an arc or other path with rotation, pivoted about a pivot point, or the like. In a preferred manifestation the substrate is pushed or tipped about a pivot point to an angle of generally 180° to minus 180°, and preferably from 100° to minus 100° by a tipping member such as a solenoid activated rod operatively connected to the step transfer apparatus. In this manner, the autodeposited film is formed having a uniform thickness on the substrate.

In a preferred embodiment, a dehydration or drying station is utilized in the step transfer apparatus. Preferably a drying station is located after one or more metal treatment, i.e. autodeposition, stations. In a preferred embodiment, a large unit or oven comprising two or more drying stations are connected in a series when a desired drying time is greater than the unit cycle time of the apparatus. The drying station includes a mechanism which aids in the drying and/or dehydration of the autodeposited composition on the electrochemically active metal substrate. Suitable drying mechanisms utilize methods which include, but are not limited to, dewatering, dehumidifying, exposure to infrared radiation, radio frequency energy (RF), convection currents, air currents, heated zones, forced air, induction, or combinations thereof. Forced air convection is preferred in one embodiment. In a preferred embodiment, the temperature ranges from 90° C. to 125° C. In some embodiments, one or more cool down stations are provided after a dehydration or drying station. Thus, in one embodiment, the travel system operatively conveys the substrate along the travel path in a drying station to a cool down station. In one embodiment, the cool down station cools a substrate under ambient temperatures, optionally utilizing blown air. In a preferred embodiment, the drying station is an oven which is configured to allow 2 to 10 racks pass therethrough or be contained therein within a given unit cycle time. Thus, the oven station is sized to provide adequate residence time for drying a coated substrate.

In yet another embodiment of the present invention, a second autodeposition coating is applied to a substrate at a second autodeposition station. In a preferred embodiment, the substrate having a first autodeposited coating thereon which has been dried at a drying station, is moved by the transfer system either from the drying station or a cool down station along the travel path to the second autodeposition coating station. There, the substrate is immersed into a second autodepositing composition for a predetermined period of time. As indicated above, the immersion time is less than the unit cycle time and ranges generally from 15 to 45 seconds, and preferably from 15 to 30 seconds. The second autodeposition coating applied on a substrate comprises a primer, an adhesive, an adhesive overcoat composition, or a combination thereof. The adhesive is any adhesive known in the art capable of bonding elastomers to metal either or pre- or post vulcanization. Dual rate withdrawal is also practiced in some embodiments as noted hereinabove and incorporated by reference during application of the second autodeposition coating at a second autodeposition station. In one embodiment, the coated substrate is removed from the autodeposition composition at a rate of 1.2 to 2.5 cm per second, and then at a rate of 0.25 to 1.0 cm per second. Preferably, the first relatively fast rate of withdrawal is performed for a duration of from 55 to 95 percent, and preferably 90 percent of total withdrawal time. Thus, the slower rate of withdrawal is practiced during 5 percent to 45 percent and preferably 10 percent of the total withdrawal time.

The film thickness of the second autodeposited composition, when measured after drying, is generally from 0.3 mil (7.62 micrometers) to 1.7 mil (43.2 micrometers) and preferably from 0.5 mil (12.7 micrometers) to 1.3 mil (33 micrometers).

In one embodiment, the second autodepositable coating is applied at the second coating station over the first coating layer prior to drying at a drying station. In a further embodiment, a second coating is applied to the first coating after the first coating has been dried at a drying station.

After the substrate has been withdrawn from the autodepositing composition contained within the second tank at the second autodeposition station, the substrate is optionally articulated as described hereinabove and subsequently transferred by the travel system to a drying station wherein the second autodeposited composition is dried. The drying conditions are preselected for drying the second composition. Drying methods and devices as disclosed herein can be utilized. The second drying station utilizes these same or a different type of drying device than the first drying station. For example, in one embodiment, the first drying step involves RF drying or a convection oven and the second drying station utilizes infrared drying or heating, etc. Multiple drying stations, often contained in a single housing such as an oven, are utilized if desired drying time is greater than the unit cycle time. Drying stations are connected in series and some embodiments to fulfill the desired drying time. Predetermined drying time ranges from 3 seconds to 10 minutes, and preferably from 30 second to 90 seconds. In one embodiment, the coated substrate is not dried at a drying station before a baking or curing step is performed at a curing station.

Curing of the substrate having one or more autodepositable coatings thereon is performed in a baking or curing step at a curing station in a preferred embodiment. The coated substrate is transferred via the travel system along each travel path from a prior station to the curing station. At the baking station, the coated substrate is heated to a temperate range of generally from 148° C. (300° F.) to 371° C. (700° F.) and preferably from 148° C. (300° F.) to 190° C. (375° F.) for a predetermined period of time. More than one curing station is utilized in some embodiments when the predetermined curing time is greater than the unit cycle time. Preferred curing times range from 1 minute to 30 minutes.

Subsequent to any desired process or processes performed on the substrate, the travel system transfers the substrate via the travel path to an unloading station. At the unloading station, the coated substrate is removed or otherwise disengaged from the travel system either manually or automatically. After the coated part is removed from the step transfer apparatus, further processing, packaging or the like is performed thereon. In one embodiment where a carriage is utilized to move a rack from station to station, the carriage is subsequently moved from a loading station along the continuous travel path through various predetermined stations and back to the loading station where additional substrates to be processed and coated are loaded onto the rack. The above described stations and processes are repeated in order to produce additional coated parts or substrates in a similar manner. The use of the square transfer apparatus of the present invention in conjunction with an autodeposition process allows coated, electrochemically active metal substrates to be rapidly produced.

As described herein above, the different embodiments of the step transfer apparatus of the present invention have various configurations and stations. In a preferred embodiment, the square transfer apparatus includes a loading station, an alkaline cleaning station, a rinse station, an acid bath pickle station, a second rinsing station, a first autodeposition coating station, a drying station, a second autodeposition coating station, a curing station, and an unloading station. In a preferred embodiment, dual rate withdrawal is practiced during the autodeposition coating steps.

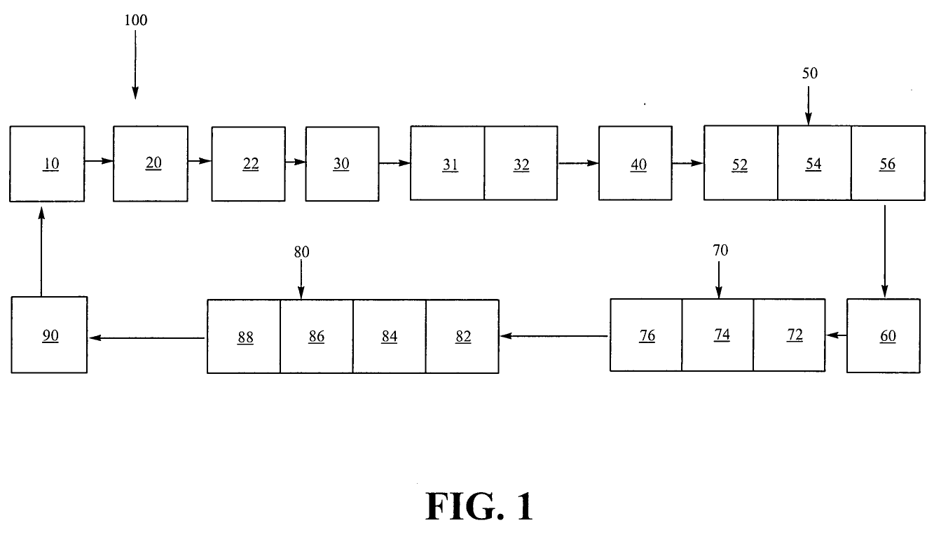

FIG. 1 illustrates a flow diagram of one preferred configuration of a square transfer apparatus of the present invention. Square transfer apparatus 100 comprises a carriage and rail system which simultaneously moves a series of racked substrates through a process sequence including stations 10-90. Square transfer apparatus carriage movement is controlled by a unit cycle time. That is, at a certain repeated time period all racked substrates are moved in unison to a subsequent work station. Different processes are performed at each work station within the unit cycle time, with some station processes being completed in a shorter amount of time than other different processes carried out a different station, all within the predetermined unit cycle time. In FIG. 1 the travel path of the square transfer apparatus begins at loading station 10 and continues through unloading station 90 and back to loading station 10. Thus, the square transfer apparatus of FIG. 1 is a continuous processing loop operation. The process flow of a substrate through the square transfer apparatus 100 is as follows.

In a first step a substrate to be coated with two autodepositable compositions is loaded onto a rack at loading station 10. Subsequently, the substrate is transferred to an alkaline bath cleaning station 20 wherein the substrate is immersed for a predetermined period of time and then withdrawn from the alkaline solution. Preferably the dipping motion is performed utilizing a hoist mechanism operatively connected to the travel system of square transfer apparatus 100. Preferably all stations which involve dipping utilize such a hoist mechanism, with each hoist mechanism programmable for different immersion and/or processing times. The substrate is transferred from the alkaline dipping station to a rinsing station 22 where the substrate is immersed in a rinse solution, preferably deionized water.

Once received at the acid pickle cleaning station 30, the substrate is immersed and withdrawn in order to further clean the substrate. Afterwards, the substrate is processed at rinsing stations 31 and 32 before being transferred to a first autodeposition coating station 40. The substrate is immersed in a first autodeposition coating composition comprising a metal treatment and withdrawn at a rate less than the drainage rate of the coating from the surface of the substrate. A dual rate of withdrawal is performed in a preferred embodiment. In order to dry or dehydrate the coating, the substrate is transferred to dehydration device 50 which includes stations 52, 54 and 56 to ensure adequate drying before a second autodeposition coating is applied at station 60. In a preferred embodiment, the autodepositable composition at station 60 is a primer, or an adhesive. The square transfer apparatus travel system conveys the substrate to drying device 70 after the second autodeposition coating has been applied. The second drying device also includes multiple dehydration stations 72, 74 and 76 to ensure adequate dehydration of the coating. The substrate is subsequently transferred to curing oven 70 including stations 82, 84, 86 and 88 wherein the substrate is cured to a predetermined degree and then transferred to unloading station 90. The cured coated substrate is removed from the rack of the square transfer apparatus 100 with the rack being transferred back to loading station 10 where the process described is then repeated.

The square transfer apparatus of the present invention utilizing autodeposition dipping has the ability to precisely coat complex parts with a uniform, thin layer of metal treatment, coating and/or adhesive.

Numerous different autodepositable coating compositions are utilized in the square transfer apparatus with the present invention to coat metal based substrates. Any autodepositable coating composition described within this specification are known in the art and are utilized in the square transfer apparatus of the present invention in one or more autodeposition stations. Preferred embodiments of the various autodeposition coating compositions are described herein. While the coating compositions are described with respect to the film forming components, it is understood that the compositions in some embodiments also contain various additives, fillers, pigments and the like as known to those of ordinary skill in the art.

### Coating Compositions

Metal Treatment Compositions

A suitable metal surface treatment composition includes (A) an aqueous dispersion of a phenolic novolac resin that includes water and a reaction product of a phenolic resin precursor, a modifying agent and optionally a multi-hydroxy phenolic compound wherein the modifying agent includes at least one functional moiety that enables the modifying agent to react with the phenolic resin precursor and at least one ionic moiety, (B) an acid, optionally, (C) a flexibilizer, and optionally (D) an accelerator or control agent. According to one embodiment, the modifying agent is an aromatic compound. According to another embodiment, the ionic moiety of the modifying agent is sulfate, sulfonate, sulfinate, sulfenate or oxysulfonate, and a dispersed phenolic resin reaction product has a carbon/sulfur atom ratio of 20:1 to 200:1. The accelerator is preferably an organic nitro material. In one embodiment, the preferred acid is phosphoric acid. A further description of suitable phenolic resin dispersions can be found within the patents incorporated by reference in this application.

The phenolic resin dispersion can be obtained by reacting or mixing a phenolic resin precursor and a modifying agent. One functional moiety of the modifying agent provides the ionic pendant group that enables stable dispersion of the phenolic resin. Without the ionic pendant group, the phenolic resin would be unable to maintain a stable dispersion in water. Since the ionic pendant group provides for the stability of the dispersion there is no need, or at the most a minimal need, for surfactants. The presence of surfactants in an aqueous composition is a well-known hindrance to the composition's performance. The other important functional moiety in the modifying agent enables the modifying agent to react with the phenolic resin precursor. The modifying agent can contain more than one ionic pendant group and more than one reaction-enabling moiety. The acid can be any acid that is capable of adjusting the pH of the adhesive composition to 1-3. Illustrative acids include hydrofluoric acid, phosphoric acid, sulfuric acid, hydrochloric acid and nitric acid. Aqueous solutions of phosphoric acid are preferred. When the acid is mixed into the composition presumably the respective ions are formed and exist as independent species in addition to the presence of the free acid. In other words, in the case of phosphoric acid, phosphate ions and free phosphoric acid co-exist in the formulated final multi-component composition. The acid preferably is present in an amount of 5 to 300 parts by weight, more preferably 10 to 160 parts by weight, based on 100 parts by weight of the phenolic resin dispersion.

In a general embodiment of the metal treatment, preferably used in a bath in the first tank for the dipping process, having a bath solids content of 3 to 20 weight %, preferably 5%-10%, and pH in the range of 1.4-3, preferably 1.4-2.5, the components include:
1. 40-50 parts by weight of an ionic modified phenol-formaldehyde resole dispersion
2. 20-30 parts of a metal activating acid
3. 1-10 parts of at least one inorganic or organic oxidizer/accelerator
4. 0-30 parts of a flexibilizer.

The following examples illustrate various active ingredients in a preferred metal treatment composition, with water bring the total wet parts to 100%. Different levels of exemplary accelerators are used at a solids content of from 5-7%.

| | | Dry Parts | | | | | |
|---|---|---|---|---|---|---|---|
| | Solids | Ex. | Ex. | Ex. | Ex. | Ex. | Ex. |
| Ingredient | Wt. % | 1 | 2 | 3 | 4 | 5 | 6 |
| Phenolic resin¹ | 20% | 49.6 | 49.6 | 47.6 | 44.4 | 44.4 | 44.4 |
| Phosphoric acid | 5% | 23.7 | 23.7 | 23.7 | 23.7 | 23.7 | 23.7 |
| NBR | 50% | 23.7 | 23.7 | 23.7 | 23.7 | 23.7 | 23.7 |
| NGD² | 0.6% | 1.00 | 0.50 | 0.83 | 2.73 | 2.05 | 1.36 |
| NBS³ | 2.5% | 2.00 | 2.50 | 4.17 | 5.47 | 6.15 | 6.84 |

| | |
|---|---|
| Immersion Time | 10 seconds |
| Dry Film Thickness | 15.24 micrometers |

¹sulfonate modified resole disclosed in U.S. Pat. No. 6,383,307 (Col. 22, lines 30-5)
²nitroguanidine
³sodium nitrobenzene sulfonate

In another embodiment, preferably for treatment over zinc-phosphatized steel, a metal treatment coating having a bath solids of 3%-10% and preferably 4-8% comprises from 25-45 parts of a ionic modified novolac resin; from 40-60 parts of a nitrile rubber latex flexibilizer; 2-15 parts phosphoric acid; and 2-6 parts of an organic oxidizer or accelerator, e.g. nitroguanidine; based on 100 parts by weight of the phenolic resin, flexibilizer polymer, acid, and accelerator. Preferably deionized water is used to adjust solids content. A formulation, preferably applied to zinc phosphatized steel is:

| | Wt.% | | Gram | Gram | % of |
|---|---|---|---|---|---|
| Raw Material | Solids | % Wet | Wet | Dry | Dry |
| Sulfonate-modified | 20% | 10.95 | 383.3 | 76.7 | 36.5% |
| novolac | | | | | |
| Nitrile rubber latex | 50% | 6.54 | 228.9 | 114.5 | 54.5% |
| Phosphoric acid | 5% | 6.6 | 231.0 | 11.6 | 5.5% |
| NG | 1% | 21 | 735.0 | 7.4 | 3.5% |
| DI Water | 0 | 54.91 | 1921.9 | 0.0 | 0% |
| Immersion time | 12 seconds | | | | |
| Dry film thickness | 14 micrometers | | | | |
| Total | 6% | 100 | 3500 | 210 | 100.0% |
| Solids content of | | | | | |
| tank | | | | | |

Surprisingly, after 500 hrs salt spray on scribed samples, the above metal treatment systems appeared clearly superior to E-coat at comparable dry film thickness and even lower film thickness with an almost complete absence of corrosion at the scribe line.

In one embodiment, the aqueous metal treatment coating composition tank comprises the following ingredients:

(A) an aqueous dispersion of a phenolic resin that includes a reaction product of
(i) a phenolic resin precursor;
(ii) a modifying agent, comprising a hydrocarbyl moiety bonded to at least one functional moiety that enables the modifying agent to react with the phenolic resin precursor; and at least one ionic moiety comprising an ionizable group containing sulfur and/or phosphorous,
(iii) at least one multi-hydroxyphenolic compound; and

(B) optionally an acid, wherein (iii) is optional in (A) when the reaction product (A) contains two or more reactive phenolic methylol groups.

According to one embodiment, the phenolic resin dispersion is made by reacting an aromatic hydrocarbyl moiety and an ionic moiety selected from sulfonate, sulfinate, sulfenate group, phosphono, —P(O)(OH)₂; phosphono ester —P(O)(OH)(OR); phosphonomethyl, —CH₂P(O)(OH)₂; phosphino, —P(O)(OH); and phosphinomethyl, —CH₂P(O)(OH), including combinations of any of these. The phenolic resin dispersion reaction product has a carbon/sulfur atom ratio preferably from 20:1 to 200:1.

Any phenolic resin is modified to form coating composition, such as an autodeposition composition. It has been found that phenolic resoles are especially suitable. The resole precursor should have a sufficient amount of active alkylol or benzyl ether groups that can initially condense with the modifying agent and then undergo further subsequent condensation. The phenolic resin precursor has a lower molecular weight than the final dispersed resin since the precursor undergoes condensation to make the final dispersed resin. Resoles are prepared by reacting a phenolic compound with an excess of an aldehyde in the presence of a base catalyst. Resole resins are usually supplied and used as reaction product mixtures of monomeric phenolic compounds and higher molecular weight condensation products having alkylol (—ArCH₂—OH) or benzyl ether termination (—ArCH₂—O—CH₂Ar), wherein Ar is an aryl group.

The accelerator or control agent component contains one or more oxidizers, for example, inorganic and/or organic oxidizers, such as alkali metal chlorate, -bromate, -perchlorate, -chlorite, -nitrate, -nitrite, -perborate, ammonium chlorate, ammonium bromate, ammonium perchlorate, ammonium chlorite, ammonium nitrate, ammonium nitrite, ammonium perborate, halo-substituted benzene sulfonic acid, alkali metal salt of halo-substituted benzene sulfonic acid, ammonium salt of halo-substituted benzene sulfonic acid, nitro-substituted benzene sulfonic acid, alkali metal salt of nitro-substituted benzene sulfonic acid, ammonium salt of nitro-substituted benzene sulfonic acid, and nitroguanidine.

The acid can be any acid that is capable of reacting with a metal to generate multivalent ions. Illustrative acids include hydrofluoric acid, phosphoric acid, sulfuric acid, hydrochloric acid and nitric acid. In the case of steel the multivalent ions will be ferric and/or ferrous ions. Aqueous solutions of phosphoric acid are preferred. When the acid is mixed into the composition presumably the respective ions are formed and exist as independent species in addition to the presence of the free acid. In other words, in the case of phosphoric acid, phosphate ions and free phosphoric acid co-exist in the formulated final multi-component composition. The acid preferably is present in an amount of 5 to 300 parts by weight, more preferably 10 to 1609 parts by weight, based on 100 parts by weight of the phenolic novolac resin dispersions (A).

Further embodiments of metal treatment compositions for use in the methods of the present invention are described in U.S. Pat. No. 6,379,752, herein incorporated by reference. Embodiments of metal treatment compositions include urethane resins, epoxy resins, polyester resins, and resins based on various acrylates. Specific examples of acrylic resins are those such as contain one or more of the following monomers: methyl acrylate, ethyl acrylate, butyl acrylate, 2-hydroxyethyl acrylate, 2-hydroxypropyl acrylate, 2-ethylhexyl acrylate, methyl methacrylate, ethyl methacrylate, n-butyl methacrylate, 2-hydroxyethyl methacrylate, 2-hydroxypropyl methacrylate, glycidyl acrylate, glycidyl methacrylate, acrylamide, methacrylamide, acrylic acid and methacrylic acid, and acrylic-alkyd resins. The latter acrylates may be present as copolymers with ethylene, styrene, vinyl chloride, vinylidene chloride and vinyl acetate. Epoxy-based resins which may also be used within the framework of the process according to the present invention are described, for example, in WO 97/07163, herein fully incorporated by reference. Apart from pure epoxy resins, epoxy acrylate-based resins are suitable. In one embodiment, after a first or metal treatment composition is applied, the coated substrate is subjected to an intermediate rinse using an aqueous solution, preferably of chromic acid or of chromates before curing or drying. The rinse step is also referred to as a reactive rinse and various concentrations of acid or of chromates are utilized. In one embodiment of the present invention, a substrate which has had a metal treatment coated thereon is subsequently rinsed in a solution or reactive rinse utilizing the electromechanical device to perform the rinse step. After the rinse step, the substrate is dried as discussed herein.

As with any of the coating compositions utilized by the methods of the present invention, other optional minor additives as adjuvants are included, depending on formulation desired. These additional components include but are not limited to thickeners; rheology modifiers: dyes; sequestering agents; biocides; dispersants; pigments, such as, titanium dioxide, organic pigments, carbon black; extenders, such as, calcium carbonate, talc, clays, silicas and silicates; fillers, such as, anti-freeze agents; plasticizers; adhesion promoters; coalescent; wetting agents; waxes; surfactants; slip additives; crosslinking agents; defoamers; colorants; tackifiers; waxes; preservatives; freeze/thaw protectors, corrosion inhibitors; anti-flocculants; and alkali or water soluble polymers.

One Coat Adhesive Composition

In a preferred embodiment, the composition applied to an electrochemically active metal substrate by the method of the present invention is a one-coat adhesive. The one-coat adhesive is applied a) directly to an electrochemically active metal substrate or b) over a substrate having a coating composition, such as an autodeposited composition previously applied thereto. The one-coat adhesive is used to bond elastomers to metals.

One preferred adhesive composition allows for the rapid autodeposition onto an electrochemically active metal substrate in a cycle time of 1 to 10 seconds. The cycle time permits the composition to be applied to the substrate utilizing the microprocessor controlled electromechanical device or system. A preferred adhesive composition comprises an autodepositable flexibilizer polymer, an acid, an accelerator, and optionally a phenolic resin.

The flexibilizer polymer is generally a latex that coagulates when exposed to the metallic ions present on the metallic substrate to form a film of uniform thickness. Suitable flexibilizer polymers are described herein. The flexibilizer polymer is present in an amount from 10 to 70 parts, and preferably 15 or 20 to 60 parts per 100 parts by dry weight of the flexibilizer, acid, accelerator and optional phenolic resin in the adhesive composition. Preferred flexibilizer polymers include styrene acrylic polymer latex and nitrile rubber latex.

Acids suitable for use in the adhesive composition have been described herein with phosphoric acid being preferred. Suitable amounts of the acid ranges generally from 5 to 20 parts and preferably from 7 to 15 parts per 100 parts dry weight of the flexibilizer, acid, accelerator and optional phenolic resin in the adhesive composition. The acid generates the metal ions of the substrate thereby activating the surface allowing coagulation of the flexibilizer polymer. The accelerator component improves the formation of the autodeposited coating on the metal substrate. The accelerator is also a crosslinker capable of bonding rubber to metal.

The accelerant or control agent may be a nitro compound, a nitroso compound, all oxime compound, a nitrate compound, or a similar material. A mixture of accelerants are used. Organic nitro compounds are the preferred accelerants.

The organic nitro compound is any material that includes a nitro group (—NO₂) bonded to an organic moiety. Preferably, the organic nitro compound is water soluble or, if water insoluble, capable of being dispersed in water. Illustrative organic nitro compounds include nitroguanidine; aromatic nitrosulfonates such as nitro or dinitrobenzenesulfonate and the salts thereof such as sodium, potassium, amine or any monovalent metal ion (particularly the sodium salt of 3,5-dinitrobenzenesulfonate); Naphthol Yellow S; and picnic acid (also known as trinitrophenol). Especially preferred for commercial availability and regulatory reasons is nitroguanidine, a mixture of nitroguanidine and sodium nitrobenzenesulfonate.

The amount of accelerants in a multi-component composition may vary, particularly depending upon the amount of any acid in the composition. Preferably, the amount is up to 20 parts, more preferably up to 10 parts, and most preferably 2 to 5 parts per 100 parts dry weight of the flexibilizer, acid, accelerator and optional phenolic resin in the adhesive composition. According to a preferred embodiment, the weight ratio of nitroguanidine to sodium nitrobenzenesulfonate should range from 1:10 to 5:1.

The organic nitro compound typically is mixed into the composition in the form of an aqueous solution or dispersion. For example, nitroguanidine is a solid at room temperature and is dissolved in water prior to formulating into the composition.

In a preferred embodiment the solids content of the adhesive composition is from 1 to 20 percent and preferably from 6 to 10 percent.

According to another adhesive embodiment, the adhesive is a one coat adhesive having a low pH (approximately 1-3) and includes (A) a flexibilizer or film-former, (B) optionally, an aqueous dispersion of a phenolic resin that includes water and a reaction product of a phenolic resin precursor, a modifying agent and, optionally, a multi-hydroxy phenolic compound, wherein the modifying agent includes at least one functional moiety that enables the modifying agent to react with the phenolic resin precursor and at least one ionic moiety, and (C) an acid. According to a more preferred embodiment of a one coat adhesive, the adhesive further includes a control agent that improves the uniformity of the film thickness formed by the adhesive. Organic nitro compounds are the preferred control agents. According to another particular embodiment of a one coat adhesive, the adhesive further includes a crosslinker that improves the adhesive performance. The crosslinker is preferably an aromatic nitroso compound or aromatic nitroso compound precursor. In one preferred embodiment, the one-coat adhesive is autodeposited on a metal substrate utilizing the electromechanical device. After further optional steps are completed, an elastomeric substrate is contacted to the coated metal substrate to effect bonding of the metal substrate to the elastomeric substrate.

The adhesive preferably contains a flexibilizer polymer. The flexibilizer is any material that contributes flexibility and/or toughness to the film formed from the composition. The toughness provided by the flexibilizer provides fracture resistance to the film. The flexibilizer should be non-glassy at ambient temperature and be an aqueous emulsion latex or aqueous dispersion that is compatible with the phenolic resin dispersion. The flexibilizer preferably is formulated into the composition in the form of an aqueous emulsion latex or aqueous dispersion.

Suitable flexibilizers include aqueous latices, emulsions or dispersions of (poly)butadiene, neoprene, styrene-butadiene rubber, acrylonitrile-butadiene rubber (also known as nitrile rubber), halogenated polyolefin, acrylic polymer, urethane polymer, ethylene-propylene copolymer rubber, ethylene-propylene-diene terpolymer rubber, styrene-acrylic copolymer, polyamide, poly(vinyl acetate) and the like. Halogenated polyolefins, nitrile rubbers and styrene-acrylic copolymers are preferred.

A suitable styrene-acrylic polymer latex is commercially available from Goodyear Tire & Rubber under the trade designation PLIOTEC and described, for example, in U.S. Pat. Nos. 4,968,741; 5,122,566 and 5,616,635. According to U.S. Pat. No. 5,616,635, such a copolymer latex is made from 45-85 weight percent vinyl aromatic monomers, 15-50 weight percent of at least one alkyl acrylate monomer and 1-6 weight percent unsaturated carbonyl compound. Styrene is the preferred vinyl aromatic monomer, butyl acrylate is the preferred acrylate monomer and acrylic acid and methacrylic acid are the preferred unsaturated carbonyl compound.

The flexibilizer or overcoating polymer is derived from polymerization of various co-monomers such as acrylic acid or various esters thereof, dicarboxylic acids, α-haloacrylonitriles such as α-bromoacrylonitrile and α-chloroacrylonitrile; α,β-unsaturated carboxylic acids such as acrylic, methacrylic, 2-ethylacrylic, 2-propylacrylic, 2-butylacrylic and itaconic acids; alkyl-2-haloacrylates such as ethyl-2-chloroacrylate and ethyl-2-bromoacrylate; α-bromovinylketone; vinylidene chloride; vinyl toluenes; vinylnaphthalenes; vinyl ethers, esters and ketones such as methyl vinyl ether, vinyl acetate and methyl vinyl ketone; esters amides, and nitriles of acrylic and methacrylic acids such as ethyl acrylate, methyl methacrylate, glycidyl acrylate, methacrylamide and acrylonitrile; and combinations of such monomers.

Suitable flexibilizers or overcoating polymers include polymers based on polyvinyl butyral and are disclosed in U.S. Pat. No. 6,433,079, herein fully incorporated by reference. Phenoxy resins based on aromatic polyether resins are also suitable flexibilizers or overcoating materials. Phenoxy resins are well known in the art and are also referred to as poly [bisphenol A-co epichlorohydrin]. They typically have molecular weights in the 20,000 range. Phenoxy resins are distinguished from thermosetting epoxy resins. Phenoxy resins are suitable overcoating polymers and are commercially available, such as Paphen® resins, PKHP 200 from Phenoxy Specialities, and from Dow Chemical under the Blox™ brand.

Suitable film forming flexibilizer and/or overcoating resins include vinylidene chloride latexes available From DOW Chemical, Imperial Chemical Industries, and Morton Chemical. Preferred film forming flexibilizers include halogenated polyolefins, chlorinated natural rubber, chlorine- and bromine-containing synthetic rubbers including polychloroprene, chlorinated polychloroprene, chlorinated polybutadiene, hexachloropentadiene, butadiene/halogenated cyclic conjugated diene adducts, chlorinated butadiene styrene copolymers, chlorinated ethylene propylene copolymers and ethylene/propylene/non-conjugated diene terpolymers, chlorinated polyethylene, chlorosulfonated polyethylene, poly(2,3-dichloro-1,3-butadiene), brominated poly(2,3-dichloro-1,3-butadiene), copolymers of (x-haloacrylonitriles and 2,3-dichloro-1,3-butadiene, chlorinated poly(vinyl chloride) and the like including mixtures of such halogen-containing film formers. A specific example of a film forming flexibilizer is chloroprene-styrene sulfonic acid-2,3-dichlorobutadiene latex. The preferred film forming flexibilizers are latexes of chlorosulfonated polyethylene, poly(2,3-dichloro-1,3-butadiene), brominated poly(2,3-dichloro-1,3-butadiene), copolymers of α-haloacrylonitriles and 2,3-dichloro-1,3-butadiene.

Solution or bulk polymerized flexibilizer polymers, not originally made as aqueous dispersions or emulsion polymers is converted to aqueous dispersions according to methods known in the art by converting organic solutions thereof into oil-in-water dispersions using a minimum stabilizing amount of monomeric and/or polymeric anionic emulsifiers and stabilizers. For example, a halogenated polyolefin is taken up in solvent. A mixture of water and emulsifier/stabilizer is added slowly under substantial agitation that provides a shearing action to the solution. Suitable representative non-polymeric anionic surfactants or emulsifiers that may be employed for converting solutions to aqueous dispersions are alkyl or aryl sulfates, alkyl or aryl sulfonates, alkyl or aryl phosphates, alkyl or aryl phosphonates, and alkyl or aryl carboxylates, and mixtures. Specific examples of anionic surfactants include sodium laural sulfate, sodium dodecyl sulfate, Triton® H-55, and monosodium N-cocyl-L-glutamate. Anionic surfactants are used alone or in combination with hydrophilic polymeric stabilizers. Upon conversion of the solution under high shear to an emulsion of the polymer, solvent is then stripped.

Autodepositable flexibilizers and overcoating polymers are readily prepared under known emulsion polymerization methods. In the embodiment employing phenolic resole dispersions, butadiene latices are particularly preferred as the flexibilizer, with nitrile butadiene copolymers being most preferred. Methods for making butadiene latices are well-known and are described, for example, in U.S. Pat. Nos. 4,054,547 and 3,920,600, both incorporated herein by reference. In addition, U.S. Pat. Nos. 5,200,459; 5,300,555; and 5,496,884 disclose emulsion polymerization of butadiene monomers in the presence of polyvinyl alcohol and a co-solvent such as an organic alcohol or a glycol. Nitrile lattices are commercially available from Noveon (formerly BFGoodrich Specialty Chemicals). Latexes, or converted dispersions may stabilized with the aforementioned monomeric anionic surfactants, hydrophilic polymeric dispersants derived from acrylic or methacrylic acid, acrylamide, substituted acrylamide; sodium vinyl sulfonate; phosphoethyl(meth)acrylate; acrylamido propane sulfonate; diacetone acrylamide; glycidyl methacrylate; acetoacetyl ethylmethacrylate and combinations thereof.

A preferred film forming latex contains bound ionic groups incorporated by aqueous polymerization techniques that involve polymerizing butadiene monomer in the presence of ethylenically functional ionic compounds such as styrene sulfonate, styrene sulfonate, poly(styrene sulfonic acid), poly(styrene sulfonate) stabilizer, sodium sulfoalkyl methacrylate, and the like. The sulfonates are salts of any cationic groups such as sodium, potassium or quaternary ammonium. Sodium styrene sulfonate is a preferred styrene sulfonate compound. Poly(styrene sulfonate) polymers include poly(styrene sulfonate) homopolymer and poly(styrene sulfonate) copolymers such as those with maleic anhydride. Sodium salts of poly(styrene sulfonate) are particularly preferred and are commercially available from National Starch under the trade designation VERSA® TL. The poly(styrene sulfonate) can have a weight average molecular weight from 5×10⁴ to 1.5×10⁶, with 1.5×10⁵ to 2.5×10⁵ being preferred. In the case of a poly(styrene sulfonate) or poly(styrene sulfonic acid) emulsion polymerization takes place in the presence of the pre-formed polymer.

The phenolic resin dispersion (B) is optional component, but typically is present in the one coat adhesive embodiment. The phenolic resin dispersion (B) is disclosed in commonly assigned PCT Patent Application Publication No. WO 99/37712, corresponding to U.S. patent application Ser. No. 09/235,777, filed Jan. 22, 1999, incorporated herein by reference. The phenolic resin dispersion (B) of the inventive composition is obtained by reacting or mixing a phenolic resin precursor and a modifying agent—theoretically via a condensation reaction between the phenolic resin precursor and the modifying agent. The phenolic resin, when present, is utilized in an amount of 5 to about 50 parts, and preferably 15 to 35 parts per 100 parts dry weight of the flexibilizer, acid, accelerator and optional phenolic resin in the adhesive composition.

The acid (C) is any acid that is capable of adjusting the pH of the adhesive composition to 1-3. Illustrative acids include hydrofluoric acid, phosphoric acid, sulfuric acid, hydrochloric acid and nitric acid. Aqueous solutions of phosphoric acid are preferred. When the acid is mixed into the composition presumably the respective ions are formed and exist as independent species in addition to the presence of the free acid. In other words, in the case of phosphoric acid, phosphate ions and free phosphoric acid co-exist in the formulated final multi-component composition.

In a preferred embodiment, an adhesive coating composition which is preferably applied to cold rolled steel or zinc treated steel, having a bath solids of 3 to 15% and preferably 4-8%, comprises from 20-40 parts of a noviak phenolic resin, 40-60 parts of a nitrile rubber latex flexibilizer, 2-6 parts of an accelerator, and 10-15 parts phosphoric acid, based on 100 parts by weight of the phenolic resin, flexibilizer, acid and accelerator. Preferably, deionized water is used to adjust the solids content. A preferred formulation is as follows:

| | Wt.% | | Gram | | |
|---|---|---|---|---|---|
| Raw Material | Solids | % Wet | Wet | Gram Dry | % of Dry |
| Carbon Black | 2% | 40.95 | 140.5 | 0.95 | 9% |
| Novolak Phenolic | 20% | 13.00 | 44.6 | 2.60 | 27% |
| Resin | | | | | |
| Phosphoric acid | 10% | 9.60 | 32.9 | 0.96 | 10% |
| Nitroguanidine | 1% | 36.00 | 123.5 | 0.36 | 4% |
| Nitrile Rubber Latex | 25% | 19.20 | 65.9 | 4.80 | 50% |
| Water | 0% | 27.00 | 92.6 | 0.00 | 0% |
| Total | 7% | 145.75 | 500.0 | 9.67 | 100.0% |
| Solids content of | | | | | |
| tank | | | | | |

Aqueous Primer Coating

In a preferred embodiment one coating for use in the methods of the present invention is a primer. In one embodiment, a suitable primer is disclosed in U.S. Pat. No. 6,476,119 herein incorporated by reference. In one preferred embodiment, the primer composition is utilized as a second coating in the electromechanical device autodeposition method. In this embodiment, the primer includes (A) an aqueous dispersion of a phenolic resin that includes water and a reaction product of a phenolic resin precursor, a modifying agent and, optionally, a multi-hydroxy phenolic compound wherein the modifying agent includes at least one functional moiety that enables the modifying agent to react with the phenolic resin precursor and at least one ionic moiety, and (B) a flexibilizer. According to one embodiment the modifying agent is an aromatic compound. According to another embodiment the ionic moiety of the modifying agent is sulfate, sulfonate, sulfinate, sulfenate or oxysulfonate and the dispersed phenolic resin reaction product has a carbon/sulfur atom ratio of 20:1 to 200:1.

The aqueous dispersion of phenolic resin and flexibilizer have been described herein. The flexibilizer is preferably present in the primer composition in an amount from 5 parts by weight to 300 parts by weight, based on 100 parts by weight of the phenolic resin dispersion. More preferably, the flexibilizer is present in an amount of 25 parts by weight to 100 parts by weight, based on 100 parts by weight of the phenolic resin dispersion. In a further preferred embodiment, the primer composition additionally includes an aldehyde, preferably formaldehyde, donor compound that is capable of crosslinking the phenolic resin.

Adhesive Overcoat Composition

In yet an additional embodiment, an adhesive overcoat composition for bonding two substrates, such as an elastomer to a metal, is utilized in the coating methods of the present invention. The adhesive overcoat composition includes (A) a flexibilizer or film-former, (B) an aqueous dispersion of a phenolic resin that includes a reaction product of a phenolic resin precursor, a modifying agent and, optionally, a multi-hydroxy phenolic compound wherein the modifying agent includes at least one functional moiety that enables the modifying agent to react with the phenolic resin precursor and at least one ionic moiety, and (C) a crosslinker. The adhesive overcoat composition is versatile and in a first embodiment is an autodeposition coating composition in the method of the present invention.

The adhesive overcoat compositions are generally two-part rubber to metal adhesive systems with the (B) aqueous dispersion of phenolic resin component and the (C) crosslinker separated in different parts prior to mixing. The remaining components are present in one part or split between both parts with the ratio of the split not being critical. The two-part system is mixed prior to application to a substrate by one of the methods of the present invention. Unexpectedly, it has been found that adhesive overcoat composition has excellent stability when formulated as a single part composition or mixed from a two-part system. In one preferred embodiment, the stability of the combined components of the adhesive overcoat composition ranges from a few hours to days, weeks, and even months. Accordingly, the adhesive overcoat compositions are not necessarily two component systems, and in one embodiment are formed as a one-part composition.

In a preferred embodiment, the adhesive overcoat compositions are applied to a treated electrochemically active metal substrate, preferably over a primer or metal treatment composition. In one embodiment, an acid component is included in the adhesive overcoat composition, which is then directly applied to an electrochemically active metal substrate. An accelerator component is utilized in a further embodiment. The application methods of the present invention enable the composition to form a self-limiting substantially uniform film.

In a preferred embodiment the crosslinker is an aromatic nitroso compound or aromatic nitroso compound precursor. The aromatic nitroso compound is any aromatic hydrocarbon, such as benzenes, naphthalenes, anthracenes, biphenyls, and the like, containing at least two nitroso groups attached directly to non-adjacent ring carbon atoms. Such aromatic nitroso compounds are described, for example, in U.S. Pat. No. 3,258,388; U.S. Pat. No. 4.119,587 and U.S. Pat. No. 5,496,884. The aromatic nitroso compound or aromatic nitroso compound precursor, if present, is preferably in an amount of 5 to 60, more preferably 20 to 30, weight percent, based on the total dry weight of the adhesive. An aromatic nitroso compound precursor is preferred.

More particularly, such nitroso compounds are described as aromatic compounds having from 1 to 3 aromatic nuclei, including fused aromatic nuclei, having from 2 to 6 nitroso groups attached directly to non-adjacent nuclear carbon atoms. The preferred nitroso compounds are the dinitroso aromatic compounds, especially the dinitrosobenzenes and dinitrosonaphthalenes, such as the meta- or para-dinitrosobenzenes and the meta- or para-dinitrosonaphthalenes. The nuclear hydrogen atoms of the aromatic nucleus can be replaced by alkyl, alkoxy, cycloalkyl, aryl, aralkyl, alkaryl, arylamine, arylnitroso, amino, halogen and similar groups. Thus, where reference is made herein to “aromatic nitroso compound” it will be understood to include both substituted and unsubstituted nitroso compounds.

Particularly preferred nitroso compounds are characterized by the formula
(R)ₘ—Ar—(NO)₂,
wherein Ar is selected from the group consisting of phenylene and naphthalene; R is a monovalent organic radical selected from the group consisting of alkyl, cycloalkyl, aryl, aralkyl, alkaryl, arylamine and alkoxy radicals having from 1 to 20 carbon atoms, amino, or halogen, and is preferably an alkyl group having from 1 to 8 carbon atoms; and m is 0,1,2,3, or4, and preferably is 0.

Exemplary suitable aromatic nitroso compounds include m-dinitrosobenzene, p-dinitrosobenzene, m-dinitrosonaphthalene, p-dinitrosonaphthalene, 2,5-dinitroso-p-cymene, 2-methyl-1,4-dinitrosobenzene, 2-methyl-5-chloro-1,4-dinitrosobenzene, 2-fluoro-1,4-dinitrosobenzene, 2-methoxy-1-3-dinitrosobenzene, 5-chloro-1,3-dinitrosobenzene, 2-benzyl-1,4-dinitrosobenzene, 2-cyclohexyl-1,4-dinitrosobenzene and combinations thereof. Particularly preferred are m-dinitrosobenzene and p-dinitrosobenzene.

The autodeposited coatings are resin-containing acidic-aqueous compositions comprising an acid, an oxidizing agent and the aqueous dispersed resin. Examples of autodeposited compositions are known. Those which are suitable in the present invention are made as set forth in European Patent Publication 0132828 and U.S. Pat. Nos. 4,647,480 and 4,186,219.

The addition polymerized resins which can be autodeposited generally comprise at least one ethylenically unsaturated monomeric compound (e.g. vinyl-based resins). The preferred ethylenically unsaturated monomers include styrene-butadiene; acrylate; alkyl-substituted acrylates such as methyl methacrylate and ethyl methacrylate; vinyl halides such as vinyl chloride; vinylidene halides such as vinylidene chloride and vinylidene dichloride; alkylenes such as ethylene; halide-substituted alkylenes such as tetrafluoroethylene; and acrylonitriles such as acrylonitrile, combinations thereof and the like.

Of the condensation type resins suitable herein are aqueous dispersions of modified phenolic novolak resins. These are the reaction product of a phenolic resin precursor, a modifying agent and a multi-hydroxy phenolic compound. The modifying agent includes at least one functional moiety that enables the modifying agent to react with the phenolic resin precursor and at least one ionic moiety. According to a preferred embodiment the modifying agent is an aromatic compound. According to another embodiment the ionic moiety of the modifying agent is sulfate, sulfonate, sulfinate, sulfenate or oxysulfonate and the dispersed phenolic resin reaction product has a carbon/sulfur atom ratio of 20:1 to 200:1.

The acid can be any acid that is capable of reacting with a metal to generate a sufficient concentration of multivalent ions. The acids which may be used in the autodepositing composition include inorganic and strong organic acids, such as, for example, hydrofluoric acid, hydrochloric acid, sulfuric acid, nitric acid, phosphoric acid, acetic acid, halogen-substituted acetic acid such as chloroacetic acid and trichloroacetic acid, and citric acid. Hydrofluoric acid is a preferred acid used in conjunction with emulsion polymerized autodeposited resins. Phosphoric acid is a preferred acid used in conjunction with modified phenolic dispersion embodiments. In the case of steel the multivalent ions liberated from the metal surface are ferric and/or ferrous ions. When the acid is mixed into the composition presumably the respective ions are formed and exist as independent species in addition to the presence of the free acid. In other words, in the case of phosphoric acid, phosphate ions and free phosphoric acid co-exist in the coating bath. As for modified phenolic dispersion embodiments, the acid preferably is present in an amount of 5 to 300 parts by weight, more preferably 10 to 160 parts by weight, based on 100 parts by weight of the resin dispersion.

The oxidizing agents which can be employed in an autodepositing composition for use in the present invention include peroxides such as hydrogen peroxide, chromates and dichromates such as chromic acid and potassium dichromate, nitrates such as nitric acid and sodium nitrate, persulfates such as sodium persulfate and ammonium persulfate, perborates such as sodium perborate, iron (III) such as ferric fluoride. Hydrogen peroxide and ferric fluoride are the preferred oxidizing agents.

Exemplary autodepositing compositions for use in the present invention are those where the resin is in the form of a latex (i.e. an emulsion polymerization product of at least one polymerizable ethylenically unsaturated monomer). Examples of such compositions include Autophoretic® 800 Series autodepositing compositions based on polyvinylidene resins and Autophoretic® 700 Series autodepositing compositions based on acrylic resins, each composition being made by Henkel. Such compositions preferably contain hydrofluoric acid and hydrogen peroxide or iron (III) fluoride as the oxidizing agent. Other commercially available autodepositable coatings are provided by Lord Corporation under the Autoseal trademark, e.g., MJ 2110 is most preferred, and is disclosed in copending application Ser. No. 09/235,201, hereby incorporated by reference. Prior to applying a dip-applied autodeposition coating, the most preferred metal treatment is provided by the use of an aqueous metal treatment primer composition disclosed in copending application Ser. No. 09/235,778 which is hereby incorporated by reference.

The coatings produced by autodepositing compounds under autodepositing conditions generally have an average nominal thickness of from 0.5 to 3 mils, preferably from about 1.0 to 2.0 mils, applied over a metal treatment having a thickness of from 0.1 to 0.5 mils ±0.05 mils. Water, preferably deionized water, is utilized to establish the predetermined solids content. Although the solids content may be varied as desired, the solids content of the coating bath is in a range of from 3 to 10%. The bath composition is waterborne and substantially free of volatile organic compounds. In the practice of the invention the range of the average DFT of autodeposited coating over the part surface is kept within ±0.3 mils, preferably ±0.2 mils, by processing a total solids bath in a range of solids of from 5 wt. % to 10%, preferably 6 wt. % solids, at a bath temperature of from 15° C. to 40° C., an Immersion time of from 20 to 80 seconds, preferably from 30 to 75 seconds, and a part withdrawal rate of from 1 to 10 ft./minute, preferably from 3 to 6 ft./min.

In a preferred embodiment of dip-applied method to coat a metal part an aqueous autodeposition bath comprises a phenolic resin dispersion, particularly an aqueous novolak dispersion and a deposition control agent and an optional flexibilizer component in admixture therewith.

This rate of autodeposition is independent of the withdrawal rate of the part. Typically the instantaneous rate of deposition slows with the elapsed immersion time. This reduction in deposition rate is referred to as “a self-limiting” feature, however to immersion time is limited to maintain an optimal DFT. Even with the formation of a gelled deposit on the immersed part, there are components of the autodeposition system that further drain from the gel as the part is withdrawn. The withdrawal rate is kept at or below the drainage rate in the practice of the invention, such that upon complete withdrawal, drip edges are reduced and most preferably eliminated. The standard deviation of DFT measured at 10 points on the surface of the part is kept to within 0.05 mils to 0.16 mils despite the slow withdrawal rates.

In the most preferred embodiment, the coating when dried is a thin, tightly bound interpenetrating organic/inorganic matrix of phenolic/metal phosphates at the metal substrate interface. This matrix can be further flexibilized with polymers. The flexibilizer is any material that contributes flexibility and/or toughness to the film formed from the composition. The toughness provided by the flexibilizer provides fracture resistance to the film. The flexibilizer should be non-glassy at ambient temperature and be an aqueous emulsion latex or aqueous dispersion that is compatible with the phenolic novolak resin dispersion. The flexibilizer preferably is formulated into the composition in the form of an aqueous emulsion latex or aqueous dispersion.

Suitable resin dispersions include aqueous latices, emulsions or dispersions of (poly)butadiene, neoprene, styrene-butadiene rubber, acrylonitrile-butadiene rubber (also known as nitrile rubber), halogenated polyolefin, acrylic polymer, urethane polymer, ethylene-propylene copolymer rubber, ethylene-propylene-diene terpolymer rubber, styrene-acrylic copolymer, polyamide, poly(vinyl acetate) and the like. Halogenated polyolefins, nitrile rubbers and styrene-acrylic copolymers are preferred.

A suitable styrene-acrylic polymer latex is commercially available from Goodyear Tire & Rubber under the trade designation PLIOTEC and described, for example, in U.S. Pat. Nos. 4,968,741; 5,122,566 and 5,616,635. According to U.S. Pat. No. 5,616,635, such a copolymer latex is made from 45-85 weight percent vinyl aromatic monomers, 15-50 weight percent of at least one alkyl acrylate monomer and 1-6 weight percent unsaturated carbonyl compound. Styrene is the preferred vinyl aromatic monomer, butyl acrylate is the preferred acrylate monomer and acrylic acid and methacrylic acid are the preferred unsaturated carbonyl compound. The mixture for making the latex also includes at least one phosphate ester surfactant, at least one water-insoluble nonionic surface active agent and at least one free radical initiator.

Nitrile rubber emulsion latex is generally made from at least one monomer of acrylonitrile or an alkyl derivative thereof and at least one monomer of a conjugated diene, preferably butadiene. According to U.S. Pat. No. 4,920,176 the acrylonitrile or alkyl derivative monomer should be present in an amount of 0 or 1 to 50 percent by weight based on the total weight of the monomers. The conjugated diene monomer should be present in an amount of 50 percent to 99 percent by weight based on the total weight of the monomers. The nitrite rubbers can also optionally include various co-monomers such as acrylic acid or various esters thereof, dicarboxylic acids or combinations thereof. The polymerization of the monomers typically is initiated via free radical catalysts. Anionic surfactants typically are also added. A suitable nitrile rubber latex is available from B.F. Goodrich under the HYCAR® mark. Representative halogenated polyolefins include chlorinated natural rubber, chlorine- and bromine-containing synthetic rubbers including polychloroprene, chlorinated polychloroprene, chlorinated polybutadiene, hexachloropentadiene, butadiene/halogenated cyclic conjugated diene adducts, chlorinated butadiene styrene copolymers, chlorinated ethylene propylene copolymers and ethylene/propylene/non-conjugated diene terpolymers, chlorinated polyethylene, chlorosulfonated polyethylene, poly(2,3-dichloro-1,3-butadiene), brominated poly(2,3-dichloro-1,3-butadiene), copolymers of α-haloacrylonitriles and 2,3-dichloro-1,3-butadiene, chlorinated poly(vinyl chloride) and the like including mixtures of such halogen-containing elastomers.

Latices of the halogenated polyolefin can be prepared according to methods known in the art such as by dissolving the halogenated polyolefin in a solvent and adding a surfactant to the resulting solution. Water can then be added to the solution under high shear to emulsify the polymer. The solvent is then stripped to obtain a latex. The latex can also be prepared by emulsion polymerization of the halogenated ethylenically unsaturated monomers.

Butadiene latices are particularly preferred as the flexibilizer. Methods for making butadiene latices are widely available commercially, and are described, for example, in U.S. Pat. Nos. 4,054,547 and 3,920,600, both incorporated herein by reference. In addition, U.S. Pat. Nos. 5,200,459; 5,300,555; and 5,496,884 disclose emulsion polymerization of butadiene monomers in the presence of polyvinyl alcohol and a co-solvent such as an organic alcohol or a glycol.

The butadiene monomers useful for preparing a butadiene polymer latex as a flexibilizer, can essentially be any monomer containing conjugated unsaturation. Typical monomers include 2,3-dichloro-1,3-butadiene; 1,3-butadiene; 2,3-dibromo-1,3-butadiene isoprene; isoprene; 2,3-dimethylbutadiene; chloroprene; bromoprene; 2,3-dibromo-1,3-butadiene; 1,1,2-trichlorobutadiene; cyanoprene; hexachlorobutadiene; and combinations thereof. It is particularly preferred to use 2,3-dichloro-1,3-butadiene since a polymer that contains as its major portion 2,3-dichloro-1,3-butadiene monomer units has been found to be particularly useful in adhesive applications due to the excellent bonding ability and barrier properties of the 2,3-dichloro-1,3-butadiene-based polymers. As described above, an especially preferred embodiment of the present invention is one wherein the butadiene polymer includes at least 60 weight percent, preferably at least 70 weight percent, 2,3-dichloro-1,3-butadiene monomer units.

The butadiene monomer can be copolymerized with other monomers. Such copolymerizable monomers include x-haloacrylonitriles such as α-bromoacrylonitrile and α-chloroacrylonitrile; α,β-unsaturated carboxylic acids such as acrylic, methacrylic, 2-ethylacrylic, 2-propylacrylic, 2-butylacrylic and itaconic acids; alkyl-2-haloacrylates such as ethyl-2-chloroacrylate and ethyl-2-bromoacrylate; α-bromovinylketone; vinylidene chloride; vinyl toluenes; vinyinaphthalenes; vinyl ethers, esters and ketones such as methyl vinyl ether, vinyl acetate and methyl vinyl ketone; esters amides, and nitriles of acrylic and methacrylic acids such as ethyl acrylate, methyl methacrylate, glycidyl acrylate, methacrylamide and acrylonitrile; and combinations of such monomers. The copolymerizable monomers, if utilized, are preferably α-haloacrylonitrile and/or α,β-unsaturated carboxylic acids. The copolymerizable monomers may be utilized in an amount of 0.1 to 30 weight percent, based on the weight of the total monomers utilized to form the butadiene polymer.

In carrying out the emulsion polymerization to produce the latex, conventional anionic and/or nonionic surfactants may be utilized in order to aid in the formation of the latex. Typical anionic surfactants include carboxylates such as fatty acid soaps from lauric, stearic, and oleic acid; acyl derivatives of sarcosine such as methyl glycine; sulfates such as sodium lauryl sulfate; sulfated natural oils and esters such as Turkey Red Oil; alkyl aryl polyether sulfates; alkali alkyl sulfates; ethoxylated aryl sulfonic acid salts; alkyl aryl polyether sulfonates; isopropyl naphthalene sulfonates; sulfosuccinates; phosphate esters such as short chain fatty alcohol partial esters of complex phosphates; and orthophosphate esters of polyethoxylated fatty alcohols. Typical nonionic surfactants include ethoxylated (ethylene oxide) derivatives such as ethoxylated alkyl aryl derivatives; mono- and polyhydric alcohols; ethylene oxide/propylene oxide block copolymers; esters such as glyceryl monostearate; products of the dehydration of sorbitol such as sorbitan monostearate and polyethylene oxide sorbitan monolaurate; amines; lauric acid; and isopropenyl halide. A conventional surfactant, if utilized, is employed in an amount of 0.01 to 5 parts, preferably 0.1 to 2 parts, per 100 parts by weight of total monomers utilized to form the butadiene polymer.

The preferred dichlorobutadiene homopolymers have a colloidal stabilizing system characterized by anionic surfactants. Such anionic surfactants include alkyl sulfonates and alkyl aryl sulfonates (commercially available from Stepan under the trade designation POLYSTEP) and sulfonic acids or salts of alkylated diphenyl oxide (for example, didodecyl diphenyleneoxide disulfonate or dihexyl diphenyloxide disulfonate commercially available from Dow Chemical Co. under the trade designation DOWFAX).

Especially preferred butadiene latexes as flexibilizers are polymerized in the presence of a styrene sulfonic acid, styrene sulfonate, poly(styrene sulfonic acid), or poly(styrene sulfonate) stabilizer to form the latex. Poly(styrene sulfonate) is the preferred stabilizer. This stabilization system is particularly effective for a butadiene polymer that is derived from at least 60 weight percent dichlorobutadiene monomer, based on the amount of total monomers used to form the butadiene polymer. The butadiene polymer latex can be made by known emulsion polymerization techniques that involve polymerizing the butadiene monomer (and copolymerizable monomer, if present) in the presence of water and the styrene sulfonic acid, styrene sulfonate, poly(styrene sulfonic acid), or poly(styrene sulfonate) stabilizer. The sulfonates can be salts of any cationic groups such as sodium, potassium or quaternary ammonium. Sodium styrene sulfonate is a preferred styrene sulfonate compound. Poly(styrene sulfonate) polymers include poly(styrene sulfonate) homopolymer and poly(styrene sulfonate) copolymers such as those with maleic anhydride. Sodium salts of poly(styrene sulfonate) are particularly preferred and are commercially available from National Starch under the trade designation VERSA TL. The poly(styrene sulfonate) can have a weight average molecular weight from 5×10⁴ to 1.5×10⁶, with 1.5×10⁵ to 2.5×10⁵ being preferred. In the case of a poly(styrene sulfonate) or poly(styrene sulfonic acid) it is important to recognize that the emulsion polymerization takes place in the presence of the pre-formed polymer. In other words, the butadiene monomer is contacted with the pre-formed poly(styrene sulfonate) or poly(styrene sulfonic acid). The stabilizer preferably is present in an amount of 0.1 to 10 parts, preferably 1 to 5 parts, per 100 parts by weight of total monomers utilized to form the butadiene polymer.

The flexibilizer, if present, preferably is included in the composition in an amount of 5 parts by weight to 300 parts by weight, based on 100 parts by weight of the preferred phenolic novolak resin dispersion. More preferably, the flexibilizer is present in an amount of 25 parts by weight to 100 parts by weight, based on 100 parts by weight of the phenolic novolak resin dispersion.

The modified phenolic resin dispersion can be cured to form a highly crosslinked thermoset via known curing methods for phenolic resins. The curing mechanism can vary depending upon the use and form of the phenolic resin dispersion. For example, curing of the dispersed resole embodiment typically can be accomplished by subjecting the phenolic resin dispersion to heat. Curing of the dispersed novolak embodiment typically can be accomplished by addition of an aldehyde donor compound.

Since the dispersed phenolic resin is a novolak, a curative should be introduced in order to cure the film formed by the metal treatment composition. It should be noted that the metal treatment composition cannot itself include a phenolic resin curative as these curatives are not storage stable under acidic conditions. Curing of the film can be accomplished by the application of a curative-containing topcoat over the metal treatment film. Typically, the metal treatment composition is applied to a metal surface (either conventionally or via autodeposition) and then dried. The curative-containing autodeposited topcoat then is applied to the thus treated metal surface. The curative contained in the topcoat can be an aldehyde donor compound or an aromatic nitroso compound. Topcoat compositions that include either one or both of these curatives are well-known and commercially available.

The aldehyde donor can be essentially be any type of aldehyde known to react with hydroxy aromatic compounds to form cured or crosslinked novolak phenolic resins. Typical compounds useful as an aldehyde (e.g., formaldehyde) source in the present invention include formaldehyde and aqueous solutions of formaldehyde, such as formalin; acetaldehyde; propionaldehyde; isobutyraldehyde; 2-ethylhexaldehyde; 2-methylpentaldehyde; 2-ethylhexaldehyde; benzaldehyde; as well as compounds which decompose to formaldehyde, such as paraformaldehyde, trioxane, furfural, hexamethylenetetramine, anhydromaldehydeaniline, ethylene diamine formaldehyde; acetals which liberate formaldehyde on heating; methylol derivatives of urea and formaldehyde; methylol phenolic compounds; and the like.

It has been found that metal parts pre-primer coated with a primer described in U.S. Ser. No. 09/235,778, formaldehyde species generated from the resole present in the primer appear to co-cure the novolak in the metal treatment coating via diffusion. In addition, curing or crosslinking of the novolak may occur through ionic crosslinking and chelation with the metal ions generated by the acid-metal substrate reaction.

Additionally, high molecular weight aldehyde homopolymers and copolymers can be employed as a latent formaldehyde source in the practice of the present invention. A latent formaldehyde source herein refers to a formaldehyde source which will release formaldehyde only in the presence of heat such as the heat applied during the curing of an adhesive system. Typical high molecular weight aldehyde homopolymers and copolymers include (1) acetal homopolymers, (2) acetal copolymers, (3) gamma-polyoxy-methylene ethers having the characteristic structure:
R₁₀O—(CH₂O)ₙ—R₁₁
and (4) polyoxymethylene glycols having the characteristic structure:
HO—(R₁₂O)ₓ—(CH₂O)ₙ—(R₁₃O)ₓ—H
wherein R₁₀ and R₁₁ can be the same or different and each is an alkyl group having from about 1 to 8, preferably 1 to 4, carbon atoms, R₁₂ and R₁₃ can be the same or different and each is an alkylene group having from 2 to 12, preferably 2 to 8, carbon atoms; n is greater than 100, and is preferably in the range from about 200 to about 2000; and x is in the range from about 0 to 8, preferably 1 to 4, with at least one x being equal to at least 1. The high molecular weight aldehyde homopolymers and copolymers are further characterized by a melting point of at least 75° C., i.e. they are substantially inert with respect to the phenolic system until heat activated; and by being substantially completely insoluble in water at a temperature below the melting point. The acetal homopolymers and acetal copolymers are well-known articles of commerce. The polyoxymethylene materials are also well known and can be readily synthesized by the reaction of monoalcohols having from 1 to 8 carbon atoms or dihydroxy glycols and ether glycols with polyoxymethylene glycols in the presence of an acidic catalyst. A representative method of preparing these crosslinking agents is described in U.S. Pat. No. 2,512,950, which is incorporated herein by reference. Gamma-polyoxymethylene ethers are generally preferred sources of latent formaldehyde and a particularly preferred latent formaldehyde source for use in the practice of the invention is 2-polyoxymethylene dimethyl ether.

The aromatic nitroso compound can be any aromatic hydrocarbon, such as benzenes, naphthalenes, anthracenes, biphenyls, and the like, containing at least two nitroso groups attached directly to non-adjacent ring carbon atoms. Such aromatic nitroso compounds are described, for example, in U.S. Pat. No. 3,258,388; U.S. Pat. No. 4,119,587 and U.S. Pat. No. 5,496,884.

The control agent mentioned above is especially useful in the metal treatment composition of the invention described above but it could also be useful in any multi-component composition that includes an autodepositable component. The autodepositable component is any material that enables (either by itself or in combination with the other components of the composition) the multi-component composition to autodeposit on a metal surface. Preferably, the autodepositable component is any water-dispersed or water soluble resin that is capable of providing autodeposition ability to the composition. It is believed that the present invention will be used most widely in connection with coatings formed from organic polymers in particular, those polymers derived from ethylenically unsaturated compounds. Other organic polymers useful in the instant invention are those that can be obtained in a form suitable for compounding into an aqueous coating bath. Organic resins include those derived from ethylenically unsaturated monomers such as polyvinylidene chloride, polyvinyl chloride, polyethylene, acrylic, acrylonitrile, polyvinyl acetate and styrene-butadiene (see U.S. Pat. Nos. 4,414,350; 4,994,521; and 5,427,863; and PCT Published Patent Application No. WO 93/15154). Urethane and polyester resins are also mentioned as being useful. Certain epoxy and epoxy-acrylate resins are also said to be useful autodeposition resins (see U.S. Pat. No. 5,500,460 and PCT Published Patent Application No. WO 97/07163). Blends of these resins may also be used.

The preferred autodepositable resins are aqueous phenolic resin dispersions described in co-pending, commonly assigned U.S. patent application Ser. No. 09/235,201, incorporated herein by reference. The novolak version of this dispersed resin is described above in connection with the metal treatment composition. There is also a resole version with which the control agent of the invention may be formulated into a multi-component composition.

The phenolic resin precursor and modifying agent used to make the dispersed resole are the same as those described for the dispersed novolak. However, the dispersed resole is produced by the reaction of 1 mol of modifying agent(s) with 1 to 20 mols of phenolic resin precursor(s). A dispersed resole typically can be obtained by reacting a resole precursor or a mixture of resole precursors with the modifying agent or a mixture of agents without any other reactants, additives or catalysts. However, other reactants, additives or catalysts can be used as desired. Multi-hydroxy phenolic compound(s) can optionally be included in relatively small amounts in the reactant mixture for the resole. Synthesis of the resole does not require an acid catalyst.

Hydrophilic resoles typically have a F/P ratio of at least 1.0. According to the invention, hydrophilic resoles having a F/P ratio much greater than 1.0 can be successfully dispersed. For example, it is possible to make an aqueous dispersion of hydrophilic resoles having a F/P ratio of at least 2 and approaching 3, which is the theoretical F/P ratio limit.

According to a particularly preferred embodiment disclosed in Ser. No. 09/235,201, wherein the dispersed phenolic resin is a resole and the modifying agent is a naphthalene having a ionic pendant group X and two reaction-enabling substituents Y, the dispersed phenolic resin reaction product contains a mixture of oligomers having structures believed to be represented by the following formula III: 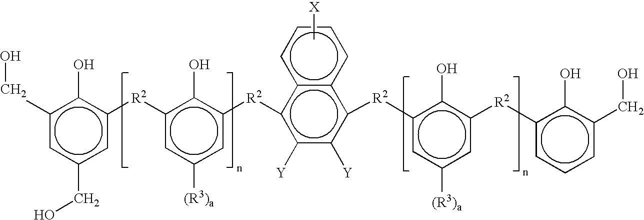
wherein X and Y are the same as in formulae Ia and Ib, a is 0 or 1; n is 0 to 5; R² is independently —C(R⁵)₂— or —C(R⁵)₂—O—C(R⁵)₂—, wherein R⁵ is independently hydrogen, alkylol, hydroxyl, alkyl, aryl or aryl ether; and R³ is independently alkylol, alkyl, aryl or aryl ether. Preferably, R² is methylene or oxydimethylene and R³ is methylol. If 6,7-dihydroxy-2-naphthalenesulfonate, sodium salt is the modifying agent, X will be SO₃⁻Na⁺ and each Y will be OH. It should be recognized that in this case the hydroxy groups for Y will also act as chelating groups with a metal ion.

The autodepositable component can be present in the composition in any amount that provides for effective autodeposition. In general, the amount can range from 1 to 50, preferably 5 to 20, and more preferably 7 to 14, weight percent, based on the total amount of non-volatile ingredients in the composition.

The control agent is any material that is able to improve the formation of an autodeposited coating on a metallic surface and, optionally, improve the formation of another autodeposited coating applied after the control agent-containing autodeposited coating. Addition of the control agent also increases the uniformity of the thickness of the autodeposited coating. The control agent-containing composition does not require an ambient staging period in order to develop fully the coating. In other words, the metallic coating conversion is complete upon drying of the coated substrate and any subsequent coating, primer or adhesive compositions can be applied immediately after coating and drying of the control agent-containing composition. The control agent also must be compatible with the other components of the composition under acidic conditions without prematurely coagulating or destabilizing the composition.

The control agent may be a nitro compound, a nitroso compound, an oxime compound, a nitrate compound, hydroxyl amine, or a similar material. A mixture of control agents may be used. Organic nitro compounds are the preferred control agents.

The organic nitro compound is any material that includes a nitro group (—NO₂) bonded to an organic moiety. Preferably, the organic nitro compound is water soluble or, if water insoluble, capable of being dispersed in water. Illustrative organic nitro compounds include nitroguanidine; aromatic nitrosulfonates such as nitro or dinitrobenzenesulfonate and the salts thereof such as sodium, potassium, amine or any monovalent metal ion (particularly the sodium salt of 3,5-dinitrobenzenesulfonate); Naphthol Yellow S; and picric acid (also known as trinitrophenol). Especially preferred for commercial availability and regulatory reasons is a mixture of nitroguanidine and sodium nitrobenzenesulfonate.

The amount of control agent(s) in a multi-component composition may vary, particularly depending upon the amount of any acid in the composition. Preferably, the amount is up to 20 weight %, more preferably up to 10 weight %, and most preferably 2 to 5 weight %, based on the total amount of non-volatile ingredients in the composition. According to a preferred embodiment, the weight ratio of nitroguanidine to sodium nitrobenzenesulfonate should range from 1:10 to 5:1.

The organic nitro compound typically is mixed into the composition in the form of an aqueous solution or dispersion. For example, nitroguanidine is a solid at room temperature and is dissolved in water prior to formulating into the composition.

The compositions of the invention may be prepared by any method known in the art, but are preferably prepared by combining and milling or shaking the ingredients and water in ball-mill, sand-mill, ceramic bead-mill, steel-bead mill, high speed media-mill or the like. It is preferred to add each component to the mixture in a liquid form such as an aqueous dispersion.

For the salt chamber test the parts are scored to the metal surface in a cross hatch pattern using a new razor blade and placed in a standard salt spray chamber for 500 hours. Evaluation of corrosion creep is made.

Experimental:

| Component | Solids | wet wt. (%) | Dry wt. (Lb) |
|---|---|---|---|
| Raven ® 14 | 100 | 0.43 | 1.448 |
| powder | | | |
| Marasperse ® | 100 | 0.14 | 0.472 |
| BBOSO-4 | | | |
| Phenolic resin | 51 | 1.42 | 19.616 |
| Ga. Pacific | | | |
| 4000 | | | |
| ABS latex | 50.250 | 10.4 | 17.696 |
| Nitroguanidine | 75 | 0.090 | 0.227 |
| Deionized | 0 | 77.52 | 00 |
| water | | | |

Withdrawal Rate for Coating: The small adhesive dip line was used to vary the withdrawal rate. The following withdrawal rates were used.
Run 1—7.5 ft/min
Run 2—5.7 ft/min
Run 3—3.4 ft/min
Run 4—1.0 ft/min
Run 5—Control—Removed manually at 40 ft/min simulating commercial withdrawal rates.

Processing of the HRS Panels is as Follows:

| Process | | Immersion | | |
|---|---|---|---|---|
| Step | Chemistry | Time | Temperature | Comments |
| Alkaline | Challenge 1245 | 4 minutes | 175° F. | 8 oz/gal; |
| Clean | | | | w/ultrasonics |
| Rinse | Tap Water | 3 minutes | RT | Air bubbler on |
| Acid | Challenge 2527 | 5 minutes | 130° F. | 7% by vol |
| Pickle | | | | w/ultrasonics |
| Rinse | Tap Water | 15 seconds | 80° F. | |
| Rinse | Tap Water | 30 seconds | 120° F. | |
| MJ Metal | MJ 1100 | 30 seconds | RT | Lot 03221006 |
| Treatment | | | | DFT Range |
| | | | | 0.19-0.25 mils |
| Dry | | 7 minutes | 220° F. | |
| Cool part | | 4 minutes | 120-130° F. | |
| MJ | MJ 2110 | 15 seconds | RT | Lot 03271006 |
| Coating | | | | |
| Dry | | 8 minutes | 200° F. | |
| B-Stage | | 20 minutes | 350° F. | Blue-M Oven |

Results:

| | Time elapsed | |
|---|---|---|
| | to last Drip | |
| Run Number | sec | DFT AVG (STDEV) |
| 1 (7.5 ft/min) | 17 sec (One | 1.03 (0.156) mils |
| | drip) | |
| 2 (5.7 ft/min) | No Drips | 1.14 (0.045) mils |
| 3 (3.4 ft/min) | No Drips | 1.15 (0.054) mils |
| 4 (1.0 ft/min) | No Drips | 1.20 (0.053) mils |
| 5 (Control) | 30 sec of Drips | 1.03 (0.152) mils |

What is claimed is:

1. A metal substrate coating device, comprising:
a square transfer apparatus comprising at least two stations, a rack, and a travel system, said travel system operatively connected to said rack and capable of transporting said rack along a travel path between said at least two stations, wherein at least one of said stations includes a dipping tank having an autodepositable coating composition therein.

2. A device according to claim 1, wherein said square transfer apparatus further includes at least one metal pretreatment station.

3. A device according to claim 2, wherein said square transfer apparatus further includes a loading station and an unloading station.

4. A device according to claim 2, wherein said square transfer apparatus includes at least two stations including dipping tanks having autodepositable coating compositions therein.

5. A device according to claim 4, wherein said square transfer apparatus is adapted to remove the substrate from the autodeposition dipping tank at a withdrawal rate which is less than the drainage rate of the autodepositable coating composition.

6. A device according to claim 5, wherein a square transfer apparatus utilizes a dual rate withdrawal wherein the substrate is removed from the autodeposition composition at a first rate of 1.2 to 2.5 cm per second and then at a rate of 0.25 to 1.0 cm per second.

7. A device according to claim 6, wherein the first rate of withdrawal is performed for a duration of from 55 to 95 percent of total withdrawal time and wherein the second rate of withdrawal is practiced during 5 to 45 percent of the total withdrawal time.

8. A device according to claim 3, wherein at least two metal pretreatment stations are utilized in the step transfer apparatus comprising an alkaline bath treating station and an acid pickle treating station.

9. A device according to claim 8, wherein the square transfer apparatus further includes a rinsing station after each metal pretreatment station.

10. A device according to claim 9, wherein a drying station is present in the step transfer apparatus after the first autodeposition coating station.

11. A device according to claim 10, wherein the first autodepositable coating composition includes a metal treatment composition, or a one coat adhesive composition, and wherein the apparatus includes at least a second autodeposition coating station with a second autodepositable coating composition comprising a primer composition or an overcoat adhesive composition.

12. A device according to claim 3, wherein the square transfer apparatus includes stations which form a continuous loop, wherein a rack is present at each said station with the racks moving in unison according to a predetermined unit cycle time from one station to the subsequent station, and wherein the unit cycle time ranges from 30 to 180 seconds.

13. A method for coating a metal substrate utilizing a step transfer apparatus, comprising the steps of:
transferring a metal substrate along a travel path utilizing a travel system of the square transfer apparatus from a prior station to an autodeposition coating station;
dipping the substrate in an autodepositable coating composition located in a tank at the autodeposition coating station; and
withdrawing the coated substrate from the autodepositable composition after a predetermined period of time which is less than a unit cycle time of the step transfer apparatus.

14. A method according to claim 13, further including the step of treating the substrate with a pretreatment solution at a pretreatment station located on the travel path before the autodeposition coating station.

15. A method according to claim 14, wherein the substrate is withdrawn from the autodepositable coating composition at a rate which is less than the drainage rate of the autodepositable coating composition.

16. A method according to claim 14, wherein the coated substrate is withdrawn at a dual rate of withdrawal wherein the substrate is removed from the autodeposition composition at a first rate of 1.2 to 2.5 cm per second and then at a rate of 0.25 to 1.0 cm per second.

17. A method according to claim 14, further including the steps of treating the substrate at at least two pretreatment stations including an alkaline bath treating station and an acid pickle treating station.

18. A method according to claim 13, further including the steps of transferring the substrate to a dehydration station after the autodepositable coating has been applied thereto, and dehydrating the coated substrate at the dehydration station.

19. A method according to claim 18, further including the steps of transferring the coated metal substrate from the dehydration station to a second autodeposition coating station, dipping the substrate in a second autodepositable coating composition located in a tank at the second autodeposition coating station, and withdrawing the coated substrate from the second autodepositable coating composition after a predetermined period of time which is less than a unit cycle time of the step transfer apparatus.

20. A method according to claim 19, further including the steps of transferring the coated metal substrate from the second autodeposition station to a second dehydration station and dehydrating the coated metal substrate.

21. A method according to claim 20, further including the step of curing the coated substrate at a station subsequent to the second dehydration station.

22. A method according to claim 13, wherein the autodepositable coating composition is a metal treatment composition, or a one coat adhesive composition.

23. A method according to claim 17, wherein the first autodepositable coating composition includes a metal treatment composition, or a one coat adhesive composition, and wherein the second autodepositable coating composition includes a primer composition or an overcoat adhesive composition.

24. A method according to claim 13, wherein the travel system comprises a carriage and rail, or a reciprocal carriage.

25. A method according to claim 23, wherein the travel system comprises a carriage and rail, or a reciprocal carriage.

26. An autodeposition coating process for forming a coating on an electrochemically active metal substrate, comprising the steps of:
providing a square transfer apparatus having a travel system capable of conveying the metal substrate between two or more stations;
performing a metal pretreatment step on the metal substrate at one station; and
applying an autodepositable coating on the metal substrate at a subsequent station.

27. A coating process according to claim 26, wherein the coating step and metal pretreatment step are each performed within a predetermined unit cycle time.

28. A coating process according to claim 27, wherein two metal pretreatment steps are performed on the metal substrate sequentially including an alkaline treatment and an acid pickle treatment.

29. A coating process according to claim 28, wherein the substrate is rinsed at a rinsing station after each metal pretreatment step is performed.

30. A coating process according to claim 29, wherein the metal substrate having an autodeposited coating thereon is transferred to a dehydration station.

31. A coating process according to claim 30, wherein a second autodepositable coating is applied to the metal substrate after the dehydration station.

32. A coating process according to claim 31, wherein the substrate is transferred to a second dehydration station after the second autodepositable coating has been applied.

33. A coating process according to claim 31, wherein the substrate is withdrawn from the autodepositable coating compositions at a rate which is less than the drainage rate of the autodepositable coating compositions.

34. A coating process according to claim 33, wherein the coated substrate is withdrawn at a dual rate of withdrawal wherein the substrate is removed from the autodeposition composition at a first rate of 1.2 to 2.5 cm per second and then at a rate of 0.25 to 1.0 cm per second.
